(19) United States
(12) Patent Application Publication
(10) Pub. No.: US 2019/0108537 A1
(43) Pub. Date: Apr. 11, 2019

(54) RECORDING MEDIUM RECORDING EVALUATION PROGRAM, EVALUATION DEVICE AND EVALUATION METHOD

(71) Applicant: FUJITSU LIMITED, Kawasaki-shi (JP)

(72) Inventors: SHUANG XU, Kawasaki (JP); Takuya AKUTSU, Kawasaki (JP); HIDEKAZU ARAI, Kawasaki (JP)

(73) Assignee: FUJITSU LIMITED, Kawasaki-shi (JP)

(21) Appl. No.: 16/149,239

(22) Filed: Oct. 2, 2018

(30) Foreign Application Priority Data
Oct. 11, 2017 (JP) 2017-197765

(51) Int. Cl. G06Q 30/02

(52) U.S. Cl. CPC G06Q 30/0206

(57) ABSTRACT

A recording medium having recording a program for causing a computer to execute processing, the processing includes calculating, for each of countries or areas, a variation rate indicating a degree of increase or decrease of an official cost officially which is calculated for each of the countries or areas with respect to a provisional cost which is calculated on the basis of cost logic for a service presented for each of the countries or areas, the cost logic including a common parameter which is defined in common to the countries or areas and an individual parameter individually which is defined for each of the countries or areas, and detecting abnormality in the common parameter, the individual parameter, a configuration of the cost logic, or a presentation mode of the service in accordance with a distribution pattern of the variation rates for the countries or areas.

### CROSS-REFERENCE TO RELATED APPLICATION

This application is based upon and claims the benefit of priority of the prior Japanese Patent Application No. 2017-197765, filed on Oct. 11, 2017, the entire contents of which are incorporated herein by reference.

### FIELD

The embodiment discussed herein is related to a recording medium recording an evaluation program, an evaluation device and an evaluation method.

### BACKGROUND

In a negotiation related to presentation of a service, there are cases where an estimate of a provisional cost is created using a cost calculation system in an initial stage of the negotiation, and thereafter, an estimate of an official cost is created on the basis of detailed conditions or the like.

The related art is disclosed in Japanese Laid-open Patent Publication No. 2002-352026 or Japanese Laid-open Patent Publication No. 2009-75961.

### SUMMARY

According to an aspect of the embodiments, a non-transitory computer-readable recording medium having stored therein an evaluation program for causing a computer to execute processing, the processing includes: calculating, for each of a plurality of countries or areas, a variation rate indicating a degree of increase or decrease of an official cost officially which is calculated for each of the plurality of countries or areas with respect to a provisional cost which is calculated on the basis of cost logic for a service presented for each of the plurality of countries or areas, the cost logic including a common parameter which is defined in common to the plurality of countries or areas and an individual parameter individually which is defined for each of the plurality of countries or areas; and detecting abnormality in the common parameter, the individual parameter, a configuration of the cost logic, or a presentation mode of the service in accordance with a distribution pattern of the variation rates for the plurality of countries or areas.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of an evaluation device according to the present embodiment;

FIG. 2 is a diagram illustrating an example of a cost logic database (DB);

FIG. 3 is a diagram illustrating information for determining a fixed value a variable value associated with a parameter of a calculation formula;

FIG. 4 is a diagram illustrating an example of a variation rate DB;

FIG. 5 is a diagram illustrating an example of a provisional cost DB;

FIG. 6 is a diagram illustrating an example of an official cost DB;

FIG. 7 is a diagram illustrating an example of a provisional cost table;

FIG. 8 is a diagram illustrating an example of a distribution pattern of condition-based variation rates in different countries;

FIG. 9 is a diagram illustrating an example of a distribution pattern of condition-based variation rates in different countries;

FIG. 10 is a diagram illustrating an example of a distribution pattern of condition-based variation rates in different countries;

FIG. 11 is a diagram illustrating an example of a distribution pattern of condition-based variation rates in different countries;

FIG. 12 is a block diagram illustrating a schematic configuration of a computer that functions as the evaluation device according to the present embodiment;

FIG. 13 is a flowchart illustrating an example of provisional cost calculation processing;

FIG. 14 is a flowchart illustrating an example of average variation rate update processing;

FIG. 15 is a flowchart illustrating an example of evaluation processing;

FIG. 16 is a diagram illustrating an example of a distribution of condition-based variation rates in different countries;

FIG. 17 is a diagram illustrating an example of a distribution of condition-based variation rates in different countries;

FIG. 18 is a diagram illustrating a relationship between a common parameter and an individual parameter;

FIG. 19 is a diagram illustrating definition of association between common parameters and individual parameters;

FIG. 20 is a diagram illustrating another example of a calculation formula;

FIG. 21 is a diagram illustrating definition of association between common parameters and individual parameters;

FIG. 22 is a diagram illustrating another example of a calculation formula; and

FIG. 23 is a diagram illustrating definition of association between common parameters and individual parameters.

### DESCRIPTION OF EMBODIMENTS

For example, there is a proposed system dealing with requests and receptions of repairs and dealing with registration and browsing of progress states of the repair between a maintenance center in charge of repairing a product such as a computer and a user. This system causes a server to write a provisional estimation of repair cost or the like into data having a repair number of the product in a repair situation database. The system subsequently checks a failure state of the product, investigates a cause of the failure, describes findings as the cause of the failure, and then, calculates an official estimation cost finally determined.

In addition, as a technology related to the service cost calculation, for example, there is a proposed operation design support system including: an operation requirement DB storing operation work items, operation requirements, and service levels; and a method of displaying content of the operation requirement DB on a screen and inputting a design item. The system also includes a data processing method for calculating the cost and creating a design document on the basis of the input design item.

With globalization of services, services may be presented through a site in each of different countries. An exemplary system for calculating a provisional cost of such a service is a system using cost logic for calculating a cost of standardized service content common to different countries for a same service. In calculating a provisional cost using such a system, there is a case where information needed for cost estimation is missing at an initial stage of the negotiation, for example. In such a case, it is conceivable to use a predetermined default value or the like for the parameters related to the missing information among the parameters included in the cost logic.

Then, when there is a difference between the default value used in provisional cost calculation or the like and a value used in official cost calculation, that difference would lead to occurrence of a difference between the provisional cost and the official cost.

There is another case where there occurs a difference between the provisional cost and the official cost because a service requested in a certain country does not correspond to the standardized service content depending on the characteristics of the country in which the service is presented. In a country requesting higher quality than the standardized service, for example, corresponding person-hours exceeding a value used in calculating the provisional cost or the like leads to a higher official cost than the provisional cost even when the service content requested is the same as the standardized service content. Conversely, in countries requesting lower costs rather than the quality of service, the official cost would be lower than the provisional cost, since the corresponding person-hours will be less than the value used in calculating the provisional cost. In addition, the official cost would be higher than the provisional cost in a country requesting additional services plus standardized services, while the official cost would be lower than the provisional cost in a country requesting omission of part of a service included in the standardized service.

It is desirable to enable accurate calculation of the provisional cost in consideration of the difference between the provisional cost and the official cost that occurs due to the above factor.

A factor that leads to lower reliability of calculation results may be evaluated in cost logic for calculating provisional costs.

Hereinafter, an exemplary embodiment will be described in detail with reference to the drawings. The present embodiment will describe a case of evaluating cost logic for calculating a provisional cost based on a standardized service, for a service presented for each of a plurality of countries or areas. Hereinafter, a country and an area will be collectively referred to as a “country”.

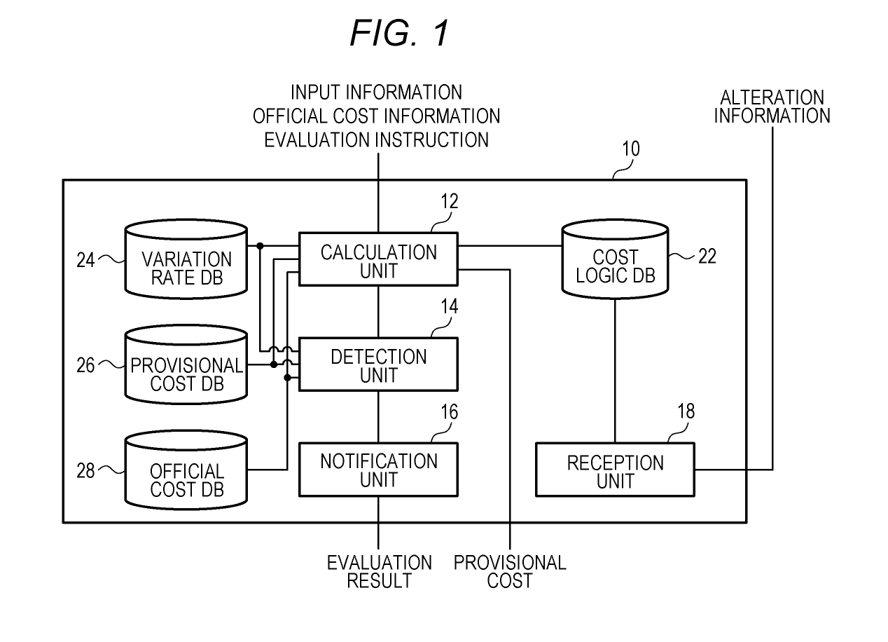

As illustrated in FIG. 1, an evaluation device 10 according to the present embodiment functionally includes a calculation unit 12, a detection unit 14, a notification unit 16, and a reception unit 18. Further, a predetermined storage region of the evaluation device 10 stores a cost logic database (DB) 22, a variation rate DB 24, a provisional cost DB 26, and an official cost DB 28. Further, the calculation unit 12 is an exemplary calculation unit according to the embodiment. The detection unit 14 is an exemplary detection unit according to the embodiment. The notification unit 16 is an exemplary notification unit according to the embodiment. The reception unit 18 is an exemplary reception unit according to the embodiment.

The calculation unit 12 receives input information for calculating a provisional cost, for example, and calculates the provisional cost on the basis of the received input information, the cost logic DB 22, and the variation rate DB 24.

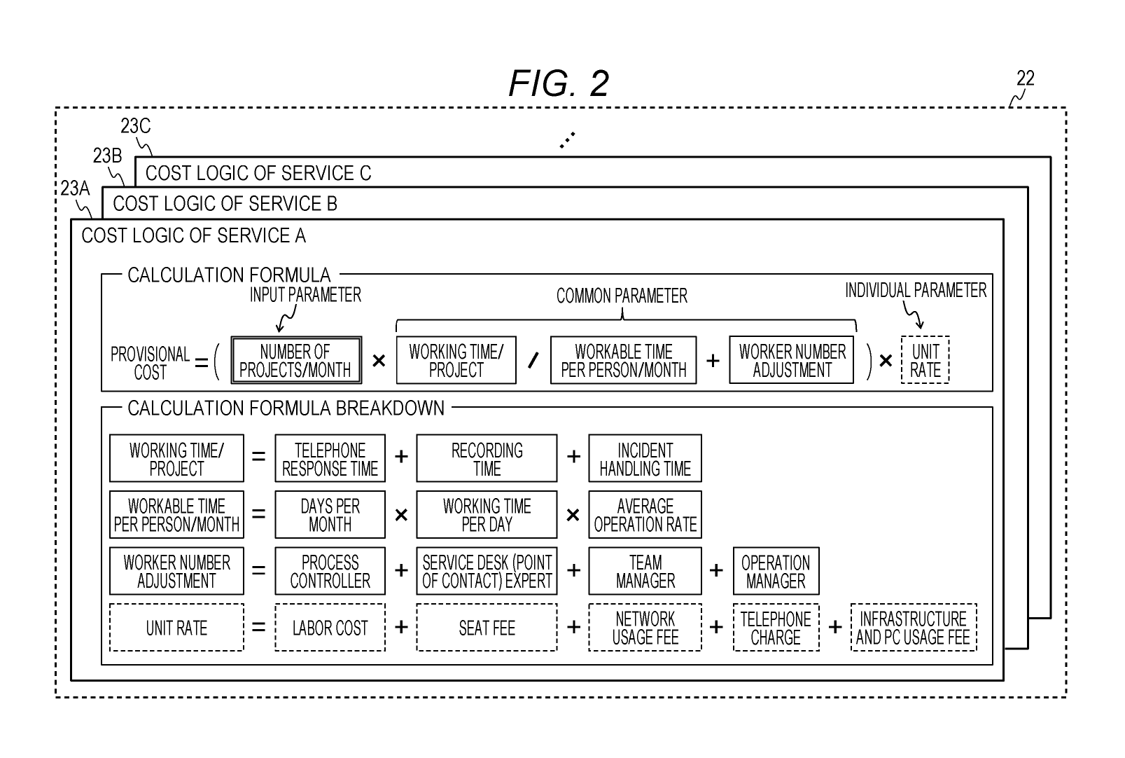

Here, the cost logic DB 22 stores various types of information for calculating a provisional cost of a standardized service for each type of service. FIG. 2 illustrates an example of the cost logic DB 22. In the example of FIG. 2, the cost logic DB 22 stores cost logic 23A of service A, cost logic 23B of service B, cost logic 23C of service C, . . . for each type of service. Hereinafter, the cost logic 23A, 23B, 23C, . . . will be collectively referred to as “cost logic 23” when there is no need to make distinction. For example, the type of service (“service A”, “service B”, or “service C” in the example of FIG. 2) corresponds to operation of a support desk, operation of a data center, or the like.

Further, each of the cost logic 23 includes a calculation formula for calculating a provisional cost and a calculation formula breakdown indicating details of the calculation formula. A calculation formula includes an input parameter different for each of projects, a common parameter defined in common with a plurality of countries, and an individual parameter individually set for each of the plurality of countries. In FIG. 2, an example of input parameters is “number of projects/month” indicated by a double line box. Further, examples of common parameters are “working time/project”, “workable time per person/month”, and “worker number adjustment” indicated by the solid line boxes. Further, an example of individual parameters is “unit rate” indicated by a broken line box. The calculation formula breakdown includes detailed parameters for calculating a value of each of the parameters. Further, each of the common parameters and the individual parameter included in the calculation formula is associated with a value used for calculating the provisional cost or associated with information for determining the value.

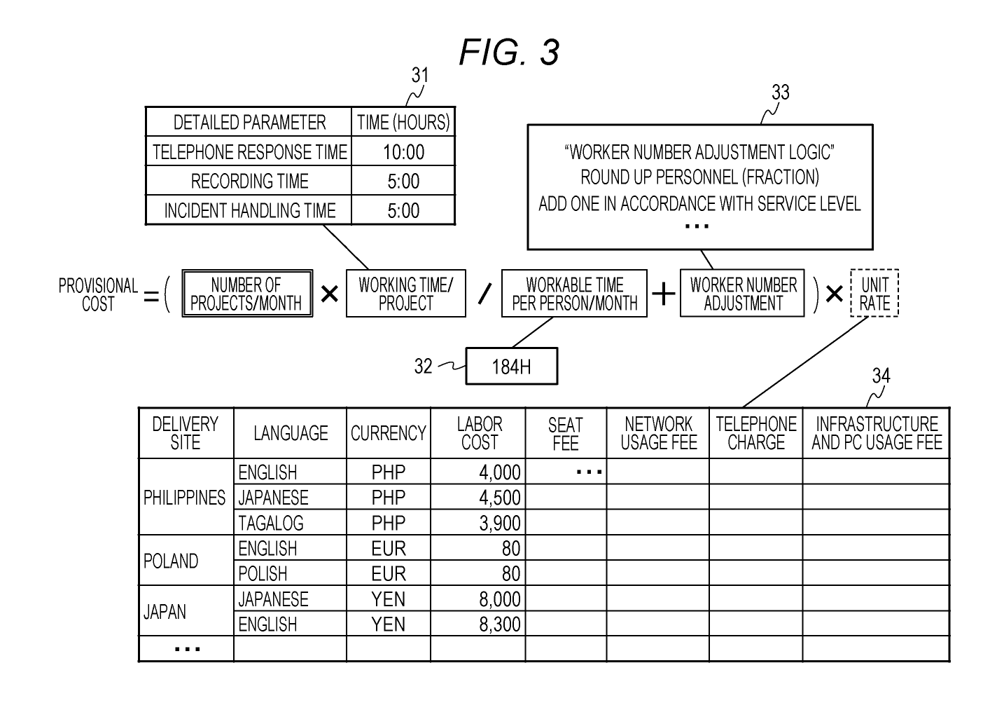

In an example of FIG. 3, the common parameter “working time/project” is associated with a table 31 defining values to be used as each of detailed parameter values of “working time/project”. The common parameter “workable time per person/month” is associated with a default value 32 used as a value of “workable time per person/month”. The common parameter “worker number adjustment” is associated with logic 33 for determining the value of “worker number adjustment”. The individual parameter “unit rate” is associated with a unit rate table 34 defining a value to be used as a value of each of detailed parameters of “unit rate” for each of “delivery site” indicating a site where a service is presented and “language” used for the service. The values of “working time/project” and “workable time per person/month” are fixed values indicated by the table 31 and the default value 32, respectively. The values of “worker number adjustment” and “unit rate” are variable values determined on the basis of the logic 33 and the unit rate table 34, respectively.

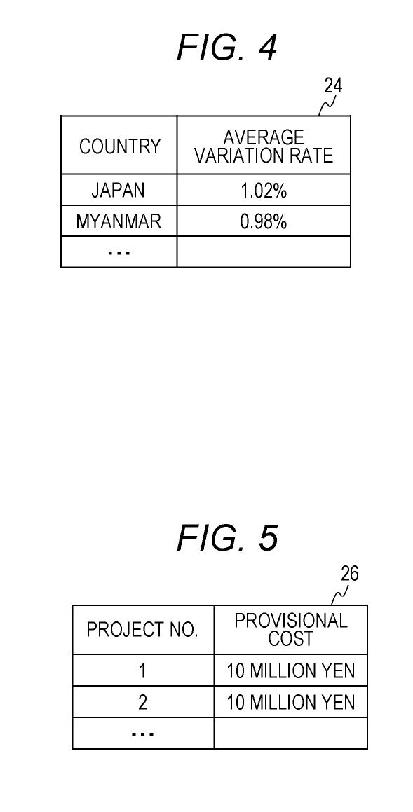

The variation rate DB 24 stores an average variation rate for each of different countries. The variation rate is a value indicating the degree of increase or decrease of the official cost officially calculated in each of the plurality of countries with respect to the provisional cost calculated on the basis of the cost logic 23. The average variation rate is an average of the variation rates that are calculated for each of the plurality of projects. This average is calculated for each of different countries. FIG. 4 illustrates an example of the variation rate DB 24.

For example, the calculation unit 12 receives input information including information indicating a type of service, a country in which the service is presented, input parameter values used in the calculation formula of the provisional cost, and information for determining a variable value of each of the common parameter and the individual parameter used in the calculation formula. For example, in the example of FIG. 3, the information for determining the variable value includes information related to “delivery site” and “language” for determining the value of each of detailed parameters of “unit rate”, a value of service level for determining the value of “worker number adjustment” and the like.

The calculation unit 12 obtains the cost logic 23 related to the type of the corresponding service from the cost logic DB 22 on the basis of the information indicating the type of service included in the input information. The calculation unit 12 further determines a parameter value being the variable value in the calculation formula included in the cost logic 23, on the basis of the information for determining the variable value. The calculation unit 12 subsequently substitutes each of the input parameter value, the fixed value, and the determined variable value included in the input information into each of the parameters of the calculation formula to calculate the provisional cost. The calculation unit 12 further obtains, from the variation rate DB 24, the average variation rate associated with the country included in the input information and multiplies the calculated provisional cost by the obtained average variation rate to calculate the final provisional cost.

The calculation unit 12 assigns the project number being project identification information to the provisional cost before undergoing multiplication by the average variation rate, and stores this provisional cost in the provisional cost DB 26. FIG. 5 illustrates an example of the provisional cost DB 26. The calculation unit 12 subsequently outputs a final provisional cost in the form of display on a display device, for example.

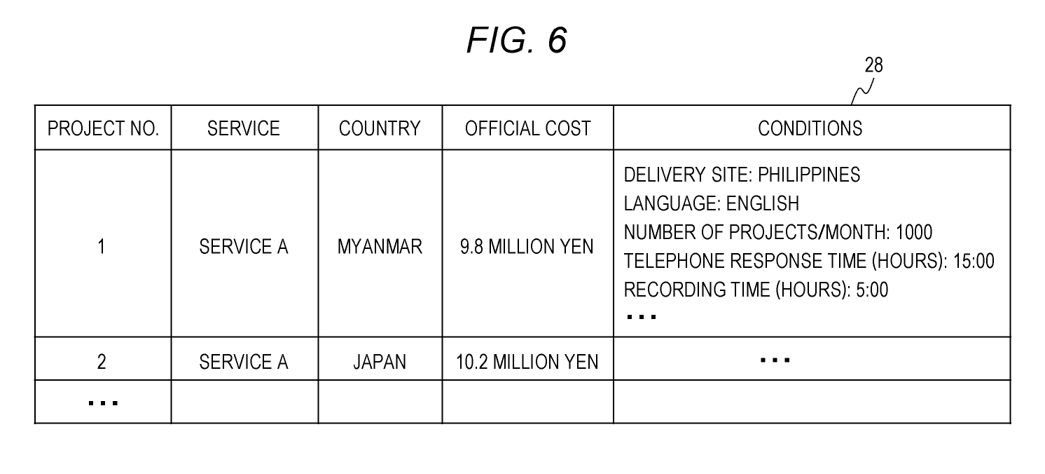

The calculation unit 12 receives official cost information, for example, and stores the received official cost information in the official cost DB 28. The official cost information is input to the evaluation device 10 in a case where the official cost of the target project has been calculated. Note that the official cost may be calculated using any type of tool.[0025] FIG. 6 illustrates an example of the official cost DB 28. In the example of FIG. 6, each of rows corresponds to one piece of official cost information. Each piece of official cost information includes information of “project number” of the target project, “service” indicating the type of service, “country”, “official cost”, and “conditions”. The information “conditions” includes a delivery site, language, and a value used to calculate the official cost.

The calculation unit 12 obtains, from the provisional cost DB 26, the provisional cost associated with the same project number as the received official cost information and calculates the variation rate of the target project. The calculation unit 12 may calculate the variation rate of the target project by obtaining a ratio “official cost/provisional cost”, for example. The calculation unit 12 subsequently updates the average variation rate associated with the country included in the official cost information in the variation rate DB 24 by using the calculated variation rate of the target project. For example, the calculation unit 12 calculates an average of a plurality of calculated variation rates of the same country including the newly calculated variation rate of the target project, and updates the average variation rate of the variation rate DB 24. Note that in a case where the newly calculated variation rate of the target project exceeds a predetermined range (for example, a range of ±5% of the official cost), the variation rate of the target project may be determined to be an abnormal value so as to be avoided in use in update of the average variation rate.

The detection unit 14 receives an evaluation instruction of the cost logic 23, for example, and calculates the variation rate for each of conditions (hereinafter referred to as “condition-based variation rate”) for each of different countries on the basis of the cost per predetermined unit (provisional cost and official cost). The cost per predetermined unit is a cost excluding influence of factors that differ among projects, such as a volume. For example, in a case where the type of service is a “service desk”, the cost per incident excluding the number of projects/month as a volume for each of projects is the cost per predetermined unit.

For example, the calculation unit 12 creates a provisional cost table including provisional costs per predetermined unit calculated from the cost logic 23 as an evaluation target. For example, the calculation unit 12 calculates the provisional cost per predetermined unit for each of combinations of the fixed value and the variable value associated with each of parameters included in the calculation formula of the cost logic 23. For example, in the example of FIG. 3, each of recorded values of the unit rate table 34 may be adopted as the value of each of detailed parameters of the individual parameter “unit rate”. Further, in correspondence with “add one in accordance with the service level” of the logic 33 associated with the common parameter “worker number adjustment”, for example, each of values of +1, +2, and +3 is adoptable in a case where the service level is defined in three levels.

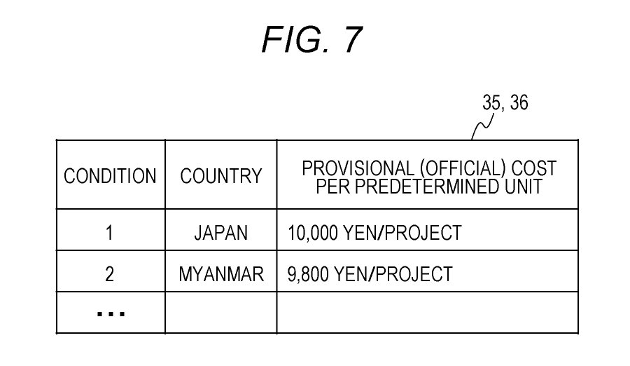

The calculation unit 12 calculates the provisional cost per predetermined unit for each of combinations of the adoptable variable values and the fixed value associated with the common parameters “working time/project” and “workable time per person/month”. Further, in the example of FIG. 3, the provisional cost calculated by the calculation formula excluding the input parameter “number of projects/month”, which is different for each of projects, is to be the provisional cost per predetermined unit. The calculation unit 12 creates a provisional cost table by associating a calculated provisional cost per predetermined unit, a condition such as the value substituted for each of parameters, and a target country. FIG. 7 illustrates an example of a provisional cost table 35. In the “condition” in the example of FIG. 7, equivalent conditions are represented by a same number. Further, the equivalent conditions are conditions having same or similar value of each parameter. Whether the parameter values are similar is to be determined by whether a difference in values between the conditions is within a predetermined range. In a case where there exists a plurality of provisional costs per predetermined unit calculated under equivalent conditions, an average of the provisional costs per predetermined unit may be stored in a field of “provisional cost per predetermined unit”.

Further, the calculation unit 12 extracts official cost information, stored in the official cost DB 28, related to the service corresponding to the cost logic 23 as an evaluation target, and calculates an official cost per predetermined unit from each of extracted pieces of official cost information. For example, the calculation unit 12 calculates the official cost per predetermined unit by excluding the value of the input parameter included in the “conditions” from the “official cost” value of the official cost information. For example, in a case where a term of the input parameter is multiplied by another term in the calculation formula, the official cost is to be divided by the value of the input parameter, thereby excluding the value of the input parameter. In a case where the term is divided by another term, the official cost is to be multiplied by the value of the input parameter, thereby excluding the value of the input parameter. For example, in a case where the term of the input parameter has been added to another term in the calculation formula, the value of the input parameter is to be subtracted from the official cost, thereby excluding the value of the input parameter. In a case where the term is subtracted by another term, the value of the input parameter is to be added to the official cost, thereby excluding the value of the input parameter. In the example of FIG. 3, since the input parameter “number of projects/month” is multiplied by another term, the calculation unit 12 divides the value of “official cost” by the value of “number of projects/month” to calculate the official cost per predetermined unit.

The calculation unit 12 associates the calculated official cost per predetermined unit, a condition such as the value substituted for each of parameters, and a target country with each other to store the association result in an official cost table. The data structure of an official cost table 36 is similar to the data structure of the provisional cost table 35 illustrated in FIG. 7.

The calculation unit 12 obtains the provisional cost per predetermined unit and the official cost per predetermined unit having “conditions” matching for each of different countries, from the provisional cost table 35 and the official cost table 36, respectively. The calculation unit 12 calculates the condition-based variation rate for each of the different countries and for each of the conditions by obtaining a ratio “official cost per predetermined unit/provisional cost per predetermined unit”, for example.

The detection unit 14 evaluates the cost logic 23 as an evaluation target according to a distribution pattern of the condition-based variation rates calculated by the calculation unit 12 for different countries. For example, in a case where the condition-based variation rate indicates an abnormal value, the detection unit 14 detects whether there is abnormality in any of the common parameter and the individual parameter included in the cost logic 23, a configuration of the cost logic 23, and a presentation mode of a service.

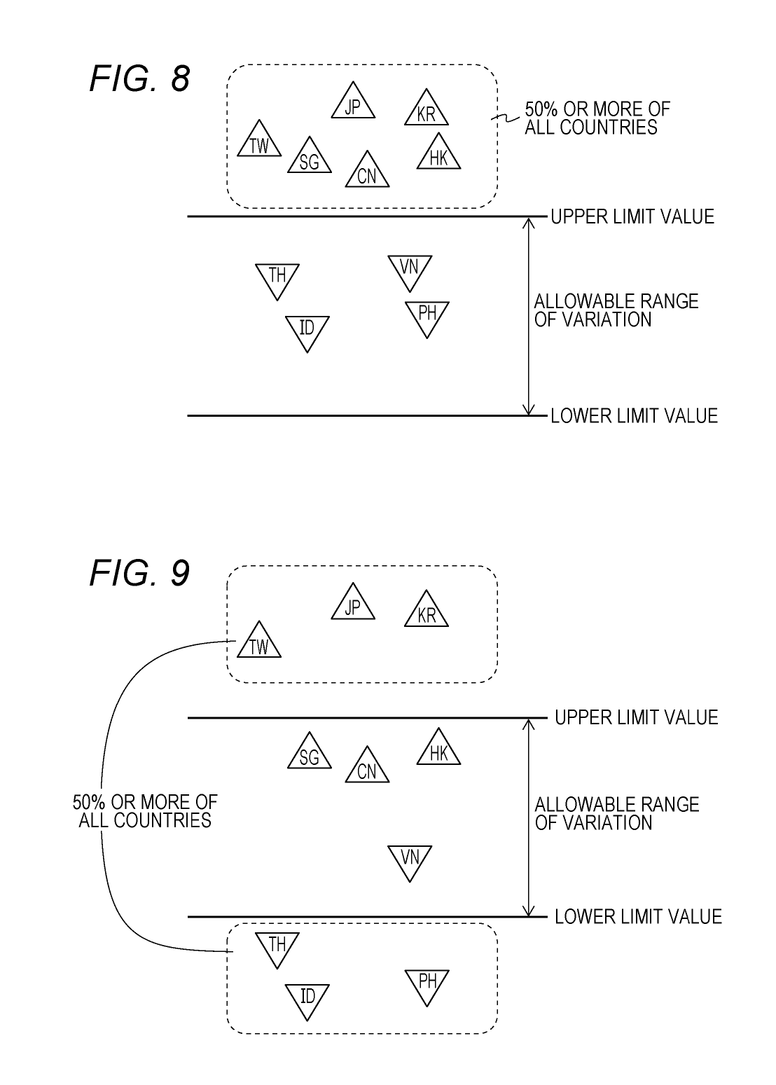

For example, the detection unit 14 detects abnormality in the common parameter in a case where the number of countries in which the condition-based variation rate exceeds an upper limit value of an allowable range of variation and the condition-based variation rate is on an increasing trend indicates a predetermined percentage (for example, 50%) or more of the total number of countries as illustrated in FIG. 8. Similarly, the detection unit 14 detects abnormality in the common parameter in a case where the number of countries in which the condition-based variation rate is below a predetermined lower limit value of the allowable range of variation and the condition-based variation rate is on a decreasing trend indicates a predetermined percentage or more of the total number of countries. The abnormality in the common parameter indicates a case, for example, where a fixed value associated with the common parameter or information for determining a variable value is not an appropriate value.

Further, the allowable range of variation may be set as the average variation rate for each of different countries±predetermined value (for example, 5% of the average variation rate). Further, in a case where the condition-based variation rate is 1 or more, the condition-based variation rate is on an increasing trend. In a case where the condition-based variation rate is below 1, the condition-based variation rate is on a decreasing trend. FIG. 8 illustrates the countries in which the condition-based variation rate is on an increasing trend by triangles, and the countries in which the condition-based variation rate is on a decreasing trend by inverted triangles. This also applies to the following FIGS. 9 to 11, 16 and 17.

In addition, the detection unit 14 detects abnormality in the configuration of the cost logic 23 in a case where the number of countries in which the condition-based variation rate is outside an allowable range of variation indicates a predetermined percentage (for example, 50%) or more of the total number of countries and there is a match in the direction of increasing or decreasing trend in the countries. Further, the match in the direction of increasing or decreasing trend means, for example, as illustrated in FIG. 9, that the condition-based variation rate is on an increasing trend when the condition-based variation rate exceeds the upper limit value of the allowable range of variation, and that the condition-based variation rate is on a decreasing trend when the condition-based variation rate is below the lower limit value of the allowable range of variation. This mode of distribution of the condition-based variation rates indicates a possibility of abnormality in the configuration of the cost logic 23. Examples of the abnormality in the configuration of the cost logic 23 include a case where the calculation formula included in the cost logic 23 has excess or lack of parameters and a case where the calculation formula is inappropriate.

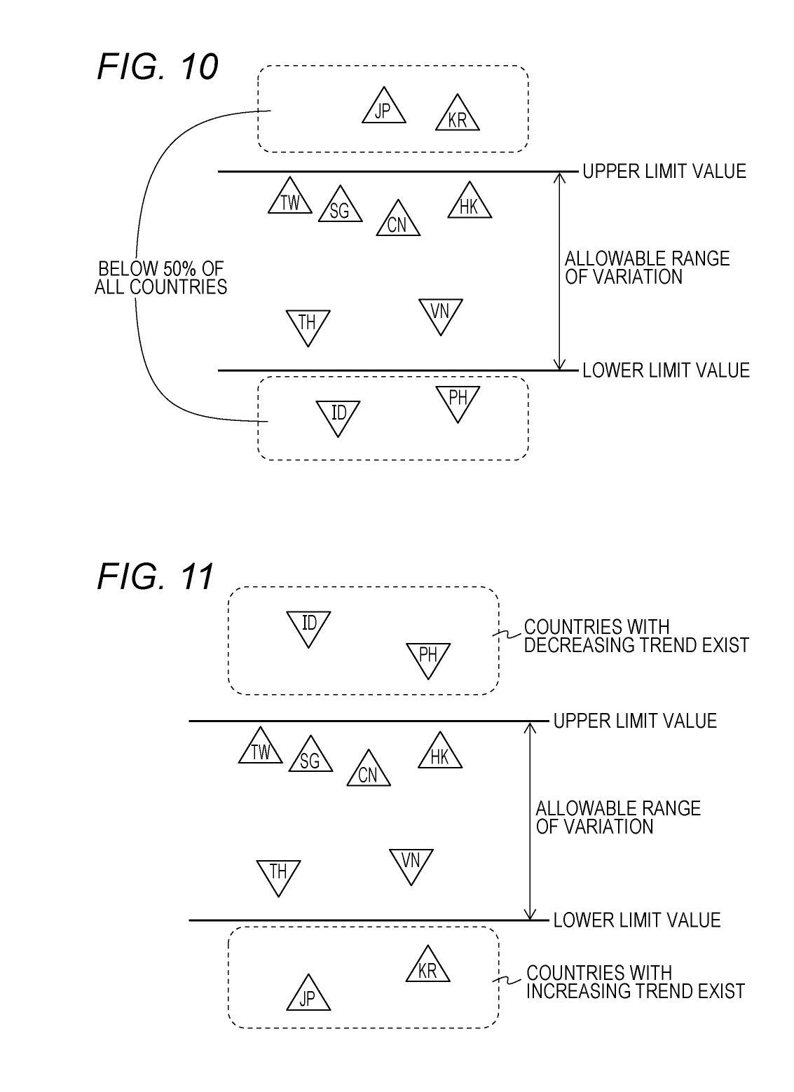

Further, as illustrated in FIG. 10, the detection unit 14 detects abnormality in the individual parameter for a country in which the condition-based variation rate is outside an allowable range of variation in a case where the number of countries in which the condition-based variation rate is outside the allowable range of variation is below a predetermined percentage (for example, below 50%) of the total number of countries. Examples of the abnormality in the individual parameter include a case where a fixed value associated with the individual parameter or information for determining a variable value is not an appropriate value.

As illustrated in FIG. 11, the detection unit 14 further detects abnormality in the presentation mode of the service in a case where there is a country in which the condition-based variation rate is on a decreasing trend among the countries in which the condition-based variation rate exceeds the upper limit value of the allowable range of variation. Similarly, the detection unit 14 detects abnormality in the presentation mode of the service in a case where there is a country in which the condition-based variation rate is on an increasing trend among the countries in which the condition-based variation rate is below the lower limit value of the allowable range of variation. Examples of the abnormality in the presentation mode of the service include a case where the delivery site at the time of calculating the official cost has been altered from the time of calculating the provisional cost, a case where the service has been significantly changed from the standardized service at the time of calculating the official cost or the like, due to price, labor cost or the like, for example.

The notification unit 16 notifies the abnormality detected by the detection unit 14 as an evaluation result. For example, the notification unit 16 may display, on a display device included in the evaluation device 10, a message indicating a possibility of abnormality detected by the detection unit 14 in at least one of the common parameter, the individual parameter, the configuration of the cost logic 23, or the presentation mode of the service.

In response to a notification by the notification unit 16, the reception unit 18 receives alteration information indicating an alteration in at least one of the common parameter, the individual parameter, and the configuration of the cost logic 23. The reception unit 18 updates the cost logic 23 included in the cost logic DB 22 on the basis of the received alteration information.

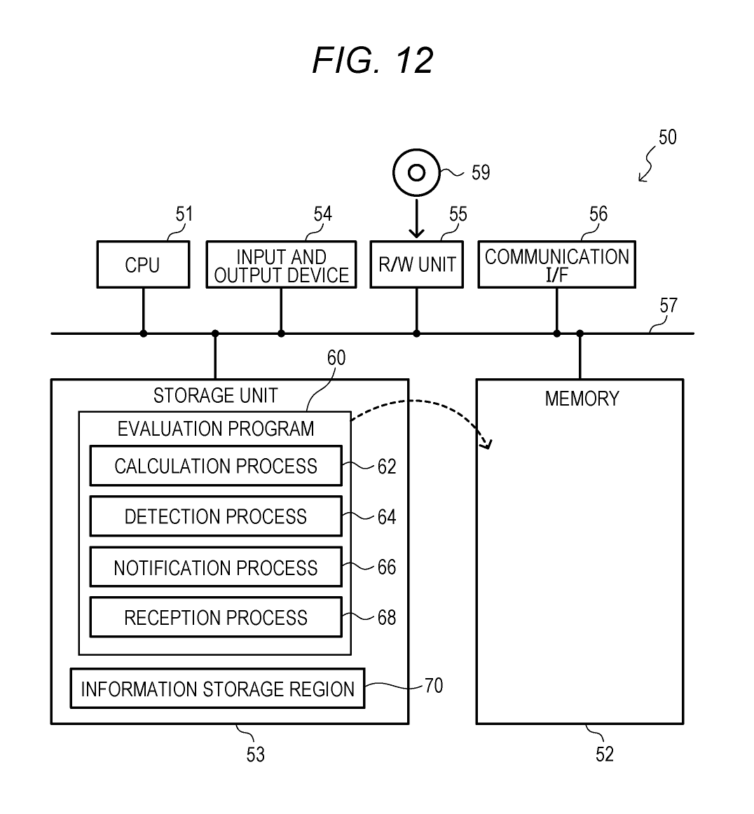

The evaluation device 10 may be realized with a computer 50 illustrated in FIG. 12, for example. The computer 50 includes a central processing unit (CPU) 51, a memory 52 as a temporary storage region, and a storage unit 53 such as a nonvolatile memory. The computer 50 also includes an input and output device 54 such as an input device and a display device, a read and write (R/W) unit 55 that controls reading and writing of data on a storage medium 59, and a communication interface (I/F) 56 coupled to a network such as the Internet. The CPU 51, the memory 52, the nonvolatile storage unit 53, the input and output device 54, the R/W unit 55, and the communication I/F 56 are coupled to one another via a bus 57.

The storage unit 53 may be realized by a hard disk drive (HDD), a solid state drive (SSD), a flash memory, or the like. The storage unit 53 functions as a storage medium and stores an evaluation program 60 for causing the computer 50 to function as the evaluation device 10. The evaluation program 60 includes a calculation process 62, a detection process 64, a notification process 66, and a reception process 68. Further, the nonvolatile storage unit 53 includes an information storage region 70 that stores information constituting each of the cost logic DB 22, the variation rate DB 24, the provisional cost DB 26, and the official cost DB 28.

The CPU 51 reads the evaluation program 60 from the storage unit 53, develops the evaluation program 60 in the memory 52, and sequentially executes the processes included in the evaluation program 60. The CPU 51 executes the calculation process 62 so as to operate as the calculation unit 12 illustrated in FIG. 1. Further, the CPU 51 executes the detection process 64 so as to operate as the detection unit 14 illustrated in FIG. 1. The CPU 51 executes the notification process 66 so as to operate as the notification unit 16 illustrated in FIG. 1. The CPU 51 executes the reception process 68 so as to operate as the reception unit 18 illustrated in FIG. 1. The CPU 51 reads information from the information storage region 70 and develops each of the cost logic DB 22, the variation rate DB 24, the provisional cost DB 26, and the official cost DB 28 onto the memory 52. As a result, the computer 50 that has executed the evaluation program 60 functions as the evaluation device 10. Further, the CPU 51 that executes the evaluation program 60 is hardware.

Alternatively, the functions realized by the evaluation program 60 may also be realized using a semiconductor integrated circuit, such as an application specific integrated circuit (ASIC).

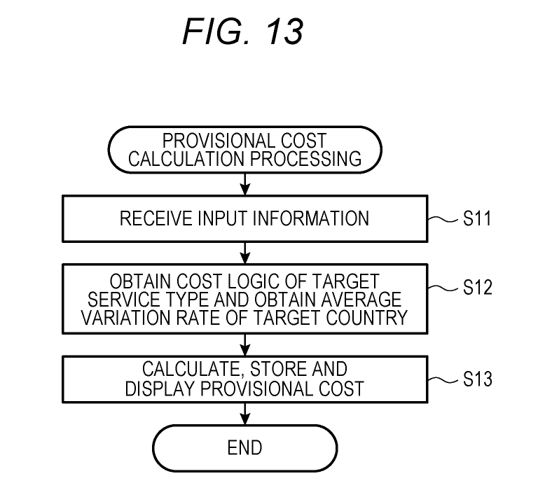

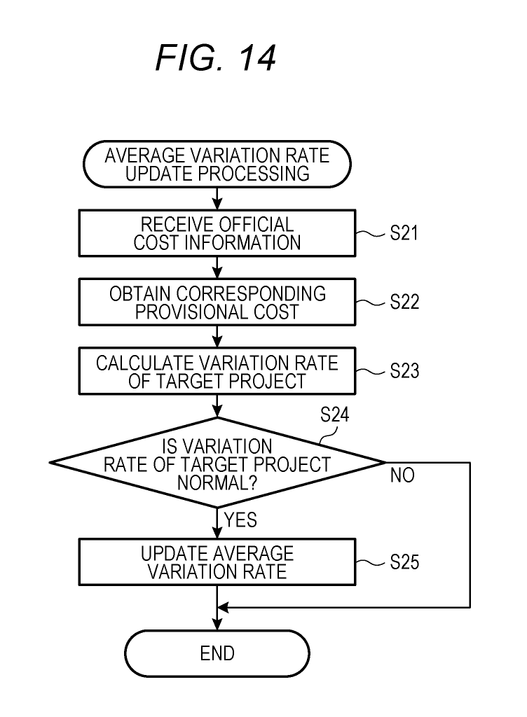

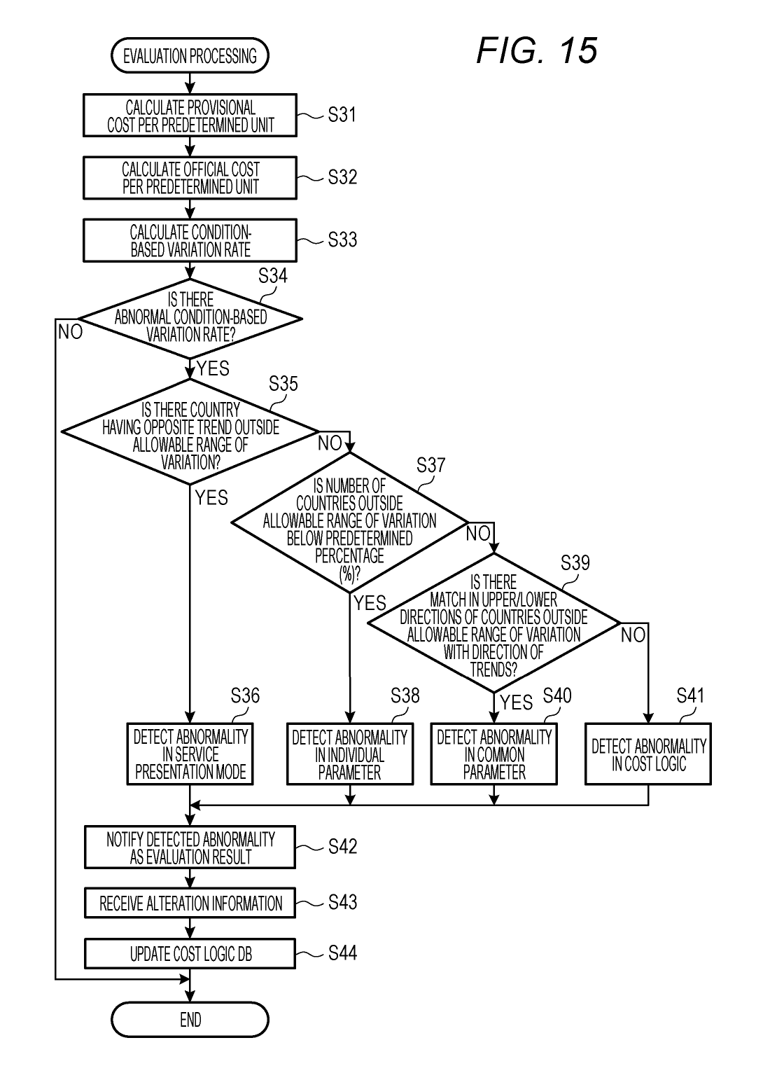

Next, operation of the evaluation device 10 according to the present embodiment will be described. Input information for calculating the provisional cost is input to the evaluation device 10 and the calculation of the provisional cost is instructed, and then, the evaluation device 10 executes the provisional cost calculation processing illustrated in FIG. 13. Further, the official cost information is input to the evaluation device 10, and then, the evaluation device 10 executes the average variation rate update processing illustrated in FIG. 14. Further, an evaluation instruction designating the cost logic 23 as an evaluation target is input to the evaluation device 10, and then, the evaluation device 10 executes the evaluation processing illustrated in FIG. 15. The provisional cost calculation processing, the average variation rate update processing, and the evaluation processing are an example of an evaluation method of the embodiment. Hereinafter, each of the provisional cost calculation processing, the average variation rate update processing, and the evaluation processing will be described in detail.

First, the provisional cost calculation processing will be described with reference to FIG. 13.

In step S11, the calculation unit 12 receives input information input to the evaluation device 10. The input information includes information indicating a type of service, a country in which the service is presented, input parameter values used in a provisional cost calculation formula, and information for determining variable values of the common parameter and the individual parameter used in the calculation formula.

Next, in step S12, the calculation unit 12 obtains the cost logic 23 related to the type of target service from the cost logic DB 22 on the basis of the information indicating the type of service included in the input information. The calculation unit 12 further obtains, from the variation rate DB 24, the average variation rate associated with the country included in the input information.

Next, in step S13, the calculation unit 12 determines a parameter value being a variable value in the calculation formula included in the cost logic 23, on the basis of the information for determining the variable value included in the input information. The calculation unit 12 subsequently substitutes each of the input parameter value, the fixed value, and the determined variable value included in the input information into each of the parameters of the calculation formula to calculate the provisional cost, assigns a project number to the calculated provisional cost, and stores the provisional cost in the provisional cost DB 26. Furthermore, the calculation unit 12 multiplies the average variation rate obtained from the variation rate DB 24 by the calculated provisional cost to calculate a final provisional cost, displays the final provisional cost on the display device, and ends the provisional cost calculation processing.

Next, the average variation rate update processing will be described with reference to FIG. 14.

In step S21, the calculation unit 12 receives the official cost information input to the evaluation device 10, and stores the received official cost information in the official cost DB 28. The official cost information includes a project number of a target project, a country in which the service is presented, the official cost, and conditions such as a delivery site, language, and values used in calculating the official cost.

Next, in step S22, the calculation unit 12 obtains, from the provisional cost DB 26, the provisional cost associated with the same project number as the received official cost information. Next, in step S23, the calculation unit 12 calculates the variation rate of the target project by “official cost/provisional cost” on the basis of the official cost included in the official cost information and the obtained provisional cost.

Next, in step S24, the calculation unit 12 determines whether the variation rate of the target project calculated in the above-described step S23 is normal. For example, in a case where the calculated variation rate of the target project exceeds a predetermined range (for example, a range of ±5% of the official cost), the calculation unit 12 determines that the variation rate of the target project is abnormal. In a case where the variation rate of the target project is normal, the processing proceeds to step S25.

In step S25, the calculation unit 12 reads an average variation rate of the same country as the country included in the official cost information received in the above-described step S21 from among the average variation rates stored in the variation rate DB 24. Further, The calculation unit 12 divides, by the number of projects, the sum of a plurality of variation rates calculated in the past to be used for calculating the average variation rate that has been read and the newly calculated variation rate of the target project to calculate the average variation rate of the target country, and updates the average variation rate of the variation rate DB 24. This completes the average variation rate update processing.

In a case where the variation rate of the target project is determined to be abnormal in the above-described step S24, the average variation rate update processing ends without updating the average variation rate.

Next, the evaluation processing will be described with reference to FIG. 15.

In step S31, the calculation unit 12 calculates a provisional cost per predetermined unit for each of conditions and for each of different countries from the cost logic 23 as an evaluation target. Further, the calculation unit 12 associates the calculated provisional cost per predetermined unit with the condition and the country to create the provisional cost table 35.

Next, in step S32, the calculation unit 12 extracts the official cost information, stored in the official cost DB 28, related to the service corresponding to the cost logic 23 as an evaluation target, and calculates the official cost per predetermined unit for each of different countries and for each of conditions from each piece of extracted official cost information. Further, the calculation unit 12 associates the calculated official cost per predetermined unit with the condition and the country to create the official cost table 36.

Next, in step S33, the calculation unit 12 obtains a provisional cost per predetermined unit and an official cost per predetermined unit in which “conditions” match for each of different countries, from the provisional cost table 35 and the official cost table 36, respectively. Further, the calculation unit 12 calculates the condition-based variation rate for each of the different countries and for each of the conditions by obtaining a ratio “official cost per predetermined unit/provisional cost per predetermined unit”, for example.

Next, the detection unit 14 executes processing of steps S34 to S42 described below for each of the conditions for the condition-based variation rate of each of the different countries calculated in the above-described step S33. Further, the processing of steps S34 to S42 described below may be executed using the condition-based variation rate of each of the different countries related to the condition of interest, in addition to the case where the condition-based variation rates for all the conditions are defined as processing targets.

In step S34, the detection unit 14 determines whether a condition-based variation rate indicating an abnormal value is included in the condition-based variation rates for the different countries calculated in the above-described step S33. For example, in a case where any of the condition-based variation rates exceeds a predetermined range (for example, a range of ±5% of the official cost), the detection unit 14 determines that the condition-based variation rate is abnormal. In a case where the condition-based variation rate indicating an abnormal value is included, the processing proceeds to step S35.

In step S35, the detection unit 14 determines whether there is a country having an opposite increasing or decreasing trend in the condition-based variation rate outside the allowable range of variation. Affirmative determination would be made in a case where there exists a country in which the condition-based variation rate is on a decreasing trend among the countries in which the condition-based variation rate exceeds the upper limit value of the allowable range of variation, or in a case where there exists a country in which the condition-based variation rate is on an increasing trend among the countries in which the condition-based variation rate is below the lower limit value of the allowable range of variation. In a case where the determination is affirmative, the processing proceeds to step S36, and the detection unit 14 detects abnormality in the presentation mode of the service. In a case where the determination is negative, on the other hand, the processing proceeds to step S37.

In step S37, the detection unit 14 determines whether the number of countries in which the condition-based variation rate is outside the allowable range of variation is below a predetermined percentage (for example, below 50%) of the total number of the countries. In a case where the determination is affirmative, the processing proceeds to step S38, and the detection unit 14 detects abnormality in the individual parameter of the country in which the condition-based variation rate is outside the allowable range of variation. In a case where the determination is negative, on the other hand, the processing proceeds to step S39.

In step S39, the detection unit 14 determines whether there is a match in the increasing or decreasing trend of countries having the condition-based variation rate outside the allowable range of variation with the increasing or decreasing trend. In a case where the determination is affirmative, the processing proceeds to step S40, and the detection unit 14 detects that the common parameter is abnormal. In a case where the determination is negative, on the other hand, the processing proceeds to step S41, and the detection unit 14 detects abnormality in the configuration of the cost logic 23.

Next, in step S42, the notification unit 16 notifies the abnormality detected by the detection unit 14 in step S36, S38, S40, or S41 as an evaluation result.

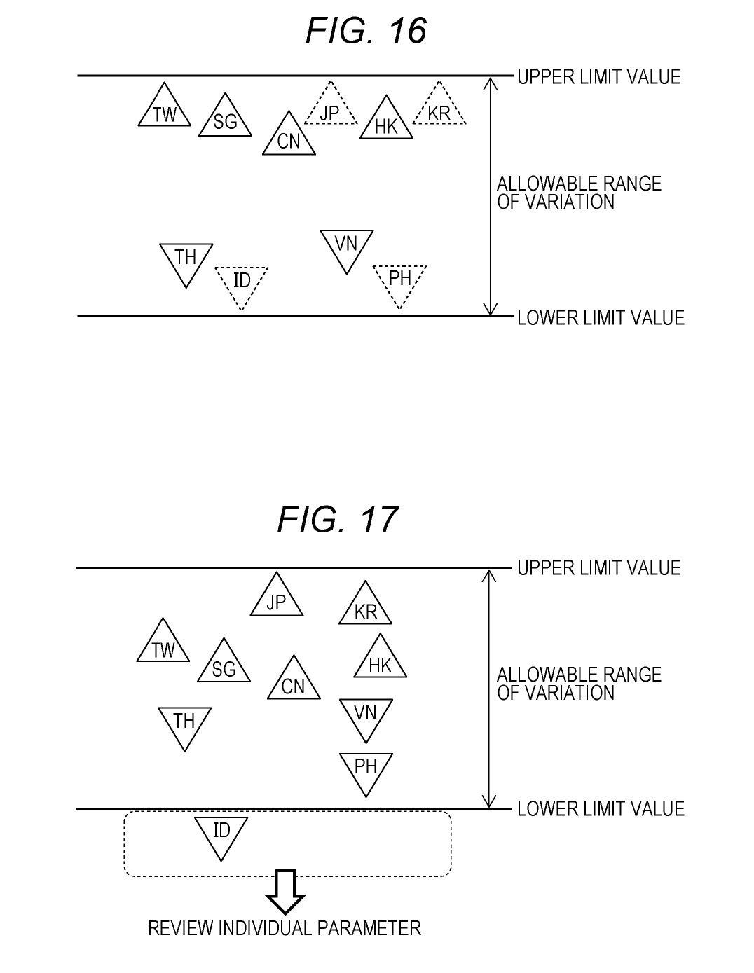

Next, in step S43, the reception unit 18 receives alteration information indicating an alteration in at least one of the common parameter, the individual parameter, and the configuration of the cost logic 23. For example, in a case where the distribution of the condition-based variation rates in different countries has a pattern illustrated in FIG. 10, it is detected in step S38 that there is abnormality in the individual parameter of the country in which the condition-based variation rate is outside the allowable range of variation. In this case, as illustrated in FIG. 16, there is an assumption of reception of alteration information of the individual parameters to enable the condition-based variation rate of a country, in which the condition-based variation rate is outside the allowable range of variation, to fall within the allowable range of variation.

Next, in step S44, the reception unit 18 updates the cost logic 23 stored in the cost logic DB 22 on the basis of the received alteration information. Further, this completes the evaluation processing.

On the other hand, in a case where the determination is negative in step S34, the evaluation processing ends without executing the processing in steps S35 to S44.

Note that the evaluation result may be temporarily stored in a predetermined storage region of the evaluation device 10 so as to be confirmed at any timing. In this case, the alteration information may be received at any timing.

As described above, the evaluation device 10 according to the present embodiment detects a location of abnormality in the cost logic by the distribution pattern of the variation rates of different countries representing the degree of increase or decrease of the official cost with respect to the provisional cost calculated on the basis of the standardized service. Accordingly, with the evaluation device 10 according to the present embodiment, it is possible to evaluate a factor that leads to lower reliability of the calculation result of the provisional cost.

In addition, the evaluation device 10 of the present embodiment updates the cost logic DB 22 on the basis of the alteration information received corresponding to the detected abnormality, and executes the provisional cost calculation processing (FIG. 14) on the basis of the updated cost logic DB 22. This may improve the reliability of the calculated provisional cost.

Further, in the above embodiment, the alteration information may be received again on the basis of the condition-based variation rate distribution of different countries after execution of the evaluation processing and the update of the cost logic DB 22. For example, in a case where the distribution of the condition-based variation rates in different countries has a pattern as illustrated in FIG. 8, abnormality in the common parameter is detected in step S40 of the evaluation processing (FIG. 15). There may be a case where common parameter alteration information is received in accordance with the evaluation result indicating the abnormality and the distribution of condition-based variation rates in different countries has been altered as illustrated in FIG. 17. In this case, it is allowable to notify an evaluation result prompting review of individual parameters of a country in which the condition-based variation rate is outside the allowable range of variation.

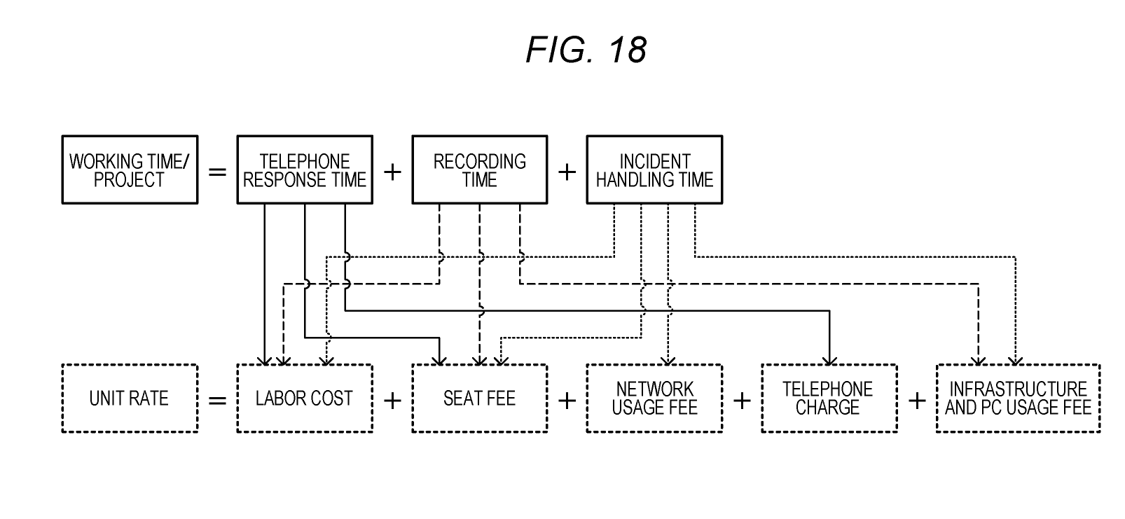

Furthermore, as exemplified in FIG. 18, there may be a case where the common parameter and the individual parameter are related to each other in calculation of the provisional cost. In a case where the alteration information related to the common parameter has been received in such a situation, it is possible to notify the evaluation result prompting the review of the individual parameter related to the common parameter. Similarly, in a case where the alteration information related to the individual parameter has been received in such a situation, it is possible to notify the evaluation result prompting the review of the common parameter related to the individual parameter.

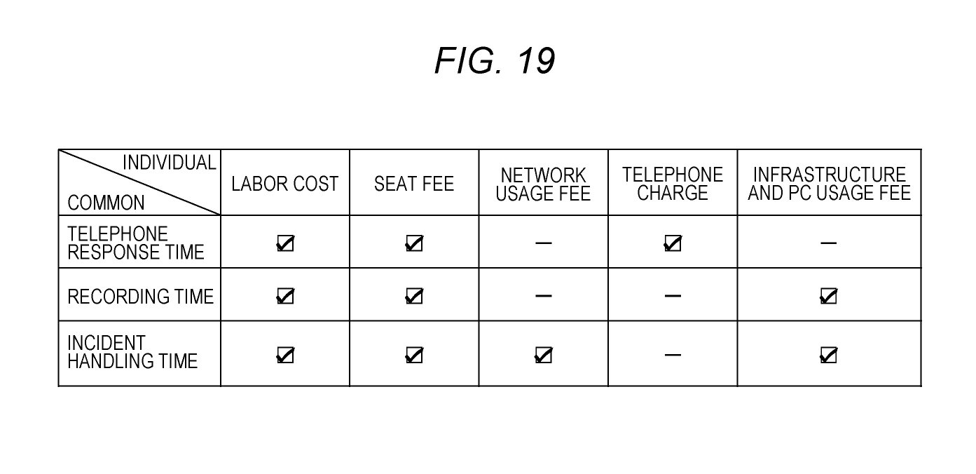

In order to realize this processing, for example, as illustrated in FIG. 19, a detailed parameter that relates to the common parameter and the individual parameter is defined. Further, in a case where the alteration information of the common parameter or the individual parameter has been received, for example, it would be preferable to display a screen as illustrated in FIG. 18 and displays a message prompting review of the corresponding parameter while presenting a related individual parameter or common parameter.

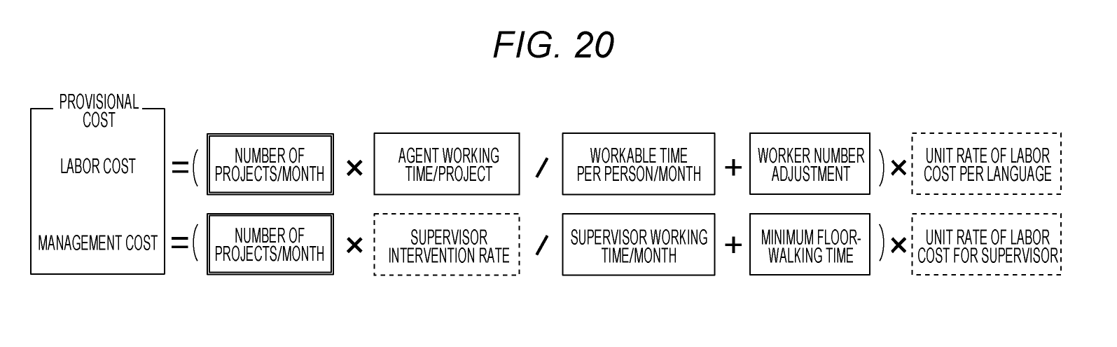

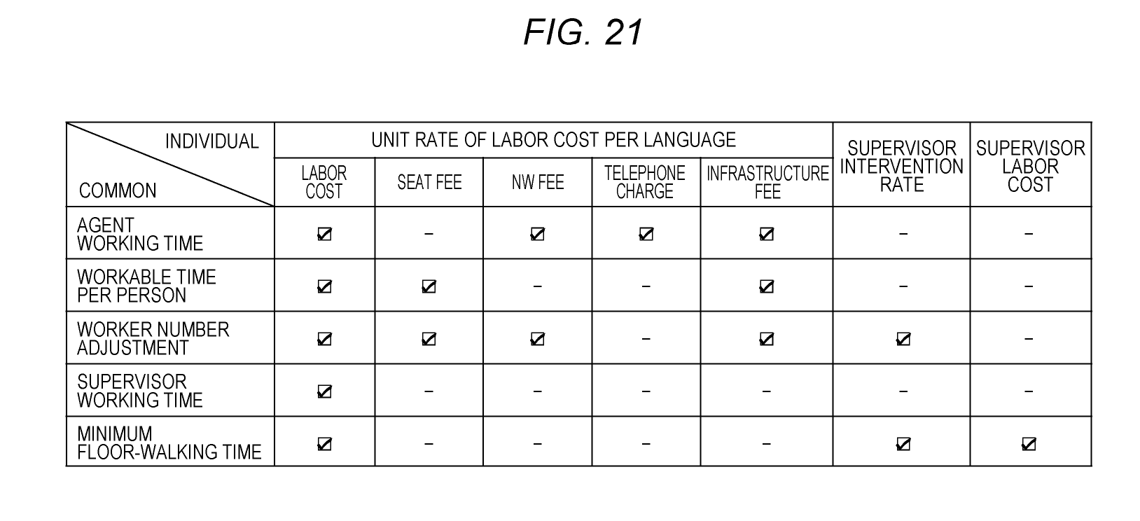

Further, while the above-described embodiment is a case of using a single calculation formula of the provisional cost included in the cost logic, the calculation formula may be divided into a plurality of formulas as illustrated in FIG. 20. Even in such a case, for example, as illustrated in FIG. 21, it is possible to define a relationship between the common parameter and the individual parameter.

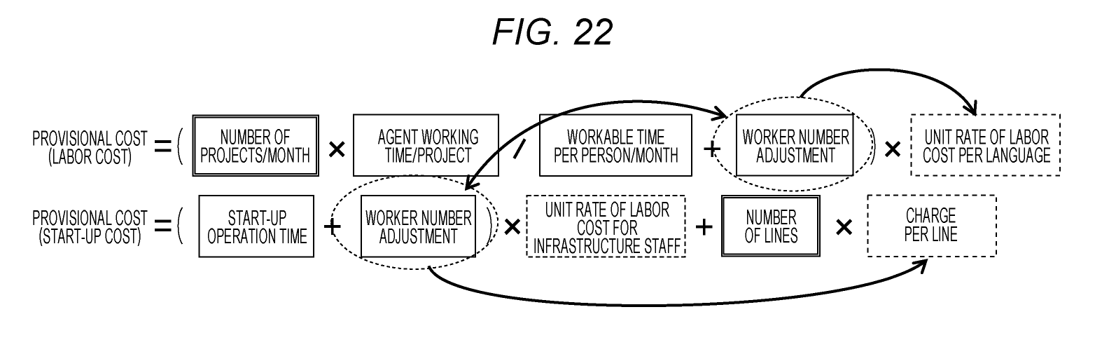

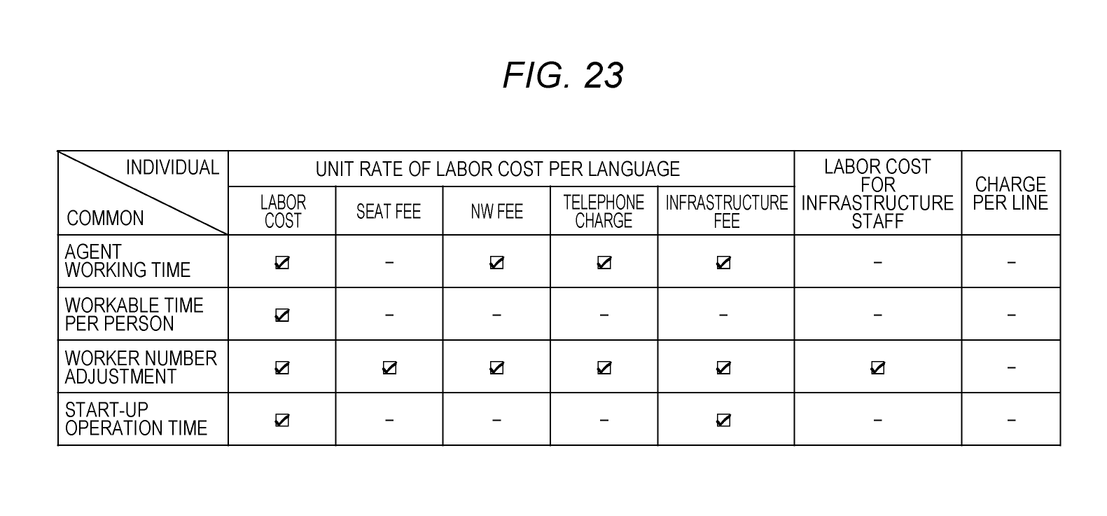

Further, as illustrated in FIG. 22, there may be cases where a common parameter is included in each of the plurality of calculation formulas. In the example of FIG. 22, while the same value is used between the calculation formula of the provisional cost (labor cost) and the calculation formula of the provisional cost (start-up cost) as the common parameter “worker number adjustment”, different values are to be used for the related individual parameter. Also in this case, the association between the common parameter and the individual parameter may be defined as illustrated in FIG. 23, for example. In the example of FIG. 23, the common parameter “worker number adjustment” included in the two calculation formulas is illustrated in one row.

Further, while the above-described embodiment corresponds to a pattern in which the evaluation program 60 is stored (installed) beforehand in the storage unit 53, provision of the program is not limited to this pattern. The program according to the embodiment may be presented in a form stored in a storage medium such as a CD-ROM, a DVD-ROM, and a USB memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an evaluation program for causing a computer to execute processing, the processing comprising:
calculating, for each of a plurality of countries or areas, a variation rate indicating a degree of increase or decrease of an official cost officially which is calculated for each of the plurality of countries or areas with respect to a provisional cost which is calculated on the basis of cost logic for a service presented for each of the plurality of countries or areas, the cost logic including a common parameter which is defined in common to the plurality of countries or areas and an individual parameter individually which is defined for each of the plurality of countries or areas; and
detecting abnormality in the common parameter, the individual parameter, a configuration of the cost logic, or a presentation mode of the service in accordance with a distribution pattern of the variation rates for the plurality of countries or areas.

2. The non-transitory computer-readable recording medium according to claim 1,
wherein the processing includes detecting abnormality in the common parameter in a case where the variation rate exceeds a predetermined upper limit value and a percentage of the countries or areas in which the variation rate is on an increasing trend is a predetermined value or more, or in a case where the variation rate is below a predetermined lower limit value and a percentage of the countries or areas in which the variation rate is on a decreasing trend is a predetermined value or more.

3. The non-transitory computer-readable recording medium according to claim 1,
wherein the processing includes detecting abnormality in the configuration of the cost logic in a case where a percentage of the countries or areas in which the variation rate is outside a predetermined allowable range is a predetermined value or more and where the variation rate exceeding an upper limit value of the allowable range is on an increasing trend and the variation rate below a lower limit value of the allowable range is on a decreasing trend.

4. The non-transitory computer-readable recording medium according to claim 1,
wherein the processing includes detecting abnormality in the individual parameter of one or more countries or areas in which the variation rate is outside a predetermined allowable range in a case where the percentage of the one or more countries or areas in which the variation rate is outside the predetermined allowable range is below a predetermined value.

5. The non-transitory computer-readable recording medium according to claim 1,
wherein the processing includes detecting abnormality in the presentation mode of the service in a case where there is a country or an area in which the variation rate is on a decreasing trend among the countries or areas in which the variation rate exceeds a predetermined upper limit value, or in a case where there is a country or an area in which the variation rate is on an increasing trend among the countries or areas in which the variation rate is below a predetermined lower limit value.

6. The non-transitory computer-readable recording medium according claim 1,
wherein the evaluation program causes the computer to execute processing further comprising:
notifying a detected abnormality; and
receiving an alteration related to the common parameter, the individual parameter, or the configuration of the cost logic.

7. The non-transitory computer-readable recording medium according to claim 6,
wherein the evaluation program causes the computer to execute processing further comprising updating the common parameter, the individual parameter, the configuration of the cost logic on the basis of the received alteration.

8. The non-transitory computer-readable recording medium according to claim 6,
wherein the evaluation program causes the computer to execute processing further comprising notifying the individual parameter related to the common parameter in a case where alteration of the common parameter has been received, as well as receiving alteration of the individual parameter that has been notified, and notifying the common parameter related to the individual parameter in a case where alteration of the individual parameter has been received, as well as receiving alteration of the common parameter that has been notified.

9. The non-transitory computer-readable recording medium according to claim 1,
wherein the processing includes reflecting, when the provisional cost is calculated for each of the plurality of countries or areas, the variation rate of the respective countries or areas which is obtained in the past to the provisional cost which is calculated on the basis of the cost logic.

10. An evaluation device comprising:
a memory; and
a processor coupled to the memory and configured to perform processing including:
calculating, for each of a plurality of countries or areas, a variation rate indicating a degree of increase or decrease of an official cost officially which is calculated for each of the plurality of countries or areas with respect to a provisional cost which is calculated on the basis of cost logic for a service presented for each of the plurality of countries or areas, the cost logic including a common parameter which is defined in common to the plurality of countries or areas and an individual parameter individually which is defined for each of the plurality of countries or areas; and
detecting abnormality in the common parameter, the individual parameter, a configuration of the cost logic, or a presentation mode of the service or in accordance with a distribution pattern of the variation rates for the plurality of countries or areas.

11. The evaluation device according to claim 10,
wherein the processing includes detecting abnormality in the common parameter in a case where the variation rate exceeds a predetermined upper limit value and a percentage of the countries or areas in which the variation rate is on an increasing trend is a predetermined value or more, or in a case where the variation rate is below a predetermined lower limit value and a percentage of the countries or areas in which the variation rate is on a decreasing trend is a predetermined value or more.

12. The evaluation device according to claim 10,
wherein the processing includes detecting abnormality in the configuration of the cost logic in a case where a percentage of the countries or areas in which the variation rate is outside a predetermined allowable range is a predetermined value or more and where the variation rate exceeding an upper limit value of the allowable range is on an increasing trend and the variation rate below a lower limit value of the allowable range is on a decreasing trend.

13. The evaluation device according to claim 10,
wherein the processing includes detecting abnormality in the individual parameter of one or more countries or areas in which the variation rate is outside a predetermined allowable range in a case where the percentage of the one or more countries or areas in which the variation rate is outside the predetermined allowable range is below a predetermined value.

14. The evaluation device according to claim 10,
wherein the processing includes detecting abnormality in the presentation mode of the service in a case where there is a country or an area in which the variation rate is on a decreasing trend among the countries or areas in which the variation rate exceeds a predetermined upper limit value, or in a case where there is a country or an area in which the variation rate is on an increasing trend among the countries or areas in which the variation rate is below a predetermined lower limit value.

15. The evaluation device according claim 10,
wherein the processing includes:
notifying a detected abnormality; and
receiving an alteration related to the common parameter, the individual parameter, or the configuration of the cost logic.

16. An evaluation method comprising:
calculating, by a computer, for each of a plurality of countries or areas, a variation rate indicating a degree of increase or decrease of an official cost officially which is calculated for each of the plurality of countries or areas with respect to a provisional cost which is calculated on the basis of cost logic for a service presented for each of the plurality of countries or areas, the cost logic including a common parameter which is defined in common to the plurality of countries or areas and an individual parameter which is individually defined for each of the plurality of countries or areas; and
detecting abnormality in the common parameter, the individual parameter, a configuration of the cost logic, or a presentation mode of the service in accordance with a distribution pattern of the variation rates for the plurality of countries or areas.

17. The evaluation method according to claim 16, further comprising:
detecting abnormality in the common parameter in a case where the variation rate exceeds a predetermined upper limit value and a percentage of the countries or areas in which the variation rate is on an increasing trend is a predetermined value or more, or in a case where the variation rate is below a predetermined lower limit value and a percentage of the countries or areas in which the variation rate is on a decreasing trend is a predetermined value or more.

18. The evaluation method according to claim 16, further comprising:
detecting abnormality in the configuration of the cost logic in a case where a percentage of the countries or areas in which the variation rate is outside a predetermined allowable range is a predetermined value or more and where the variation rate exceeding an upper limit value of the allowable range is on an increasing trend and the variation rate below a lower limit value of the allowable range is on a decreasing trend.

19. The evaluation method according to claim 16, further comprising:
detecting abnormality in the individual parameter of one or more countries or areas in which the variation rate is outside a predetermined allowable range in a case where the percentage of the one or more countries or areas in which the variation rate is outside the predetermined allowable range is below a predetermined value.

20. The evaluation method according to claim 16, further comprising:
detecting abnormality in the presentation mode of the service in a case where there is a country or an area in which the variation rate is on a decreasing trend among the countries or areas in which the variation rate exceeds a predetermined upper limit value, or in a case where there is a country or an area in which the variation rate is on an increasing trend among the countries or areas in which the variation rate is below a predetermined lower limit value.
